(19) United States
(12) Patent Application Publication
(10) Pub. No.: US 2004/0073523 A1
(43) Pub. Date: Apr. 15, 2004

(54) Mail processing apparatus

(75) Inventor: Hirokazu Shimizu, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 10/681,092

(22) Filed: Oct. 9, 2003

(30) Foreign Application Priority Data
Oct. 15, 2002 (JP) 300544/2002

(51) Int. Cl. G06F 17/00

(52) U.S. Cl. 705/406; 705/401

(57) ABSTRACT

A height-sizing portion picks up postal items of non-standard sizes, and a stamp side-detecting portion determines on which side of each of the postal items a stamp is affixed. Based on information determined by the stamp side-detecting portion, a sorting portion sorts the postal items using a paddle. The paddle has guide members for adjusting the ranges of the postal items when sorted. A raising portion having multiple elastic rollers with different mounting angles varying from tilted to erect aligns the postal items so that the stamp sides face the same direction. The faced postal items are cancelled with a postmark on an ink-jet printer.

### BACKGROUND OF THE PRESENT INVENTION

1. Field of the Invention

The present invention relates to a mail processing apparatus, and particularly to a mail processing apparatus for automatic culling, facing, and canceling of non-standard-sized mail.

2. Description of the Related Art

In the field of mail processing, postal service providers have introduced automated processing equipment for culling, facing, and canceling of standard-sized mail. Thus the automation has already proceed with processing standard-sized mail. However, since non-standard-sized mail varies in size, thickness, weight, and so on, as different from standard-sized mail, the conventional automated processing equipment for standard-sized mail cannot handle non-standard-sized mail.

For example, the conventional equipment has performed processing for aligning standard-sized postal items in the following manner so that the stamp sides face the same direction. Postal items with the stamps on the top side are fed to a straight transport belt. On the other hand, postal items with the stamps on the back side are fed between transport belts twisted 180 degrees so that they are turned top side down. The postal items fed from the respective transport belts are then merged.

In this structure, however, the belts may not be able to hold heavy or thick postal items. Further, when a large or heavy postal item is rotated along the twisted belts, a large centrifugal force is applied to the postal item and it may cause the postal item to jump out of the belts. For these reasons, the conventional technique cannot be applied to non-standard-sized mail that varies in size, weight, and thickness.

Because of these technical problems, a sequence of operations for culling, facing, and canceling non-standard-sized mail has not been automated yet, except for disclosure of apparatuses capable of full automation of canceling only (for example, see Japanese Patent Laid-Open No. 2003-137469).

For automated feeding of postal items, mechanisms related to a paper sheet feeder and feeding method are disclosed (for example, see Japanese Patent Laid-Open Nos. 2000-109221 and 2000-109230).

In a paper sheet sealing device described in Japanese Patent Laid-Open No. 2003-137469, automation of canceling non-standard-sized mail is implemented. The paper sheet sealing device, however, requires a worker(s) to manually cull and align postal items to be canceled so that their right side (up and down, and top and back) is aligned before the postal items cancelled with a postmark. In the mail processing, it takes a lot of trouble and time to perform the culling and facing processes. Under the circumstances, the automated canceling process has not directly led to an improvement in throughput, a reduction in the number of man-hours, an elimination of human error, and a cost reduction.

### SUMMARY OF THE INVENTION

It is an object of the present invention to provide a mail processing apparatus capable of significantly automating a sequence of operations for culling, facing, and canceling non-standard-sized mail so that large amounts of mail can be processed securely in a shorter amount of time.

According to the present invention, a mail processing apparatus includes: a stamp side-detecting portion for determining on which side of each of postal items a stamp is affixed; a paddle for sorting the postal items based on information determined by the stamp side-detecting portion; and a facing portion for aligning the postal items so that their stamp sides face the same direction.

The paddle has guide members for adjusting the ranges of the postal items when sorted.

The facing portion has a raising portion for raising the postal items sorted by the paddle so that the postal items are transported in an erect state.

The raising portion has multiple elastic rollers with different mounting angles varying from tilted to erect.

### BRIEF DESCRIPTION OF THE DRAWINGS

The above and other objects, features, and advantages of the present invention will become apparent from the following detailed description when taken with the accompanying drawings in which:

FIG. 1 is a perspective view showing the structure of an embodiment according to the present invention;

FIG. 2 is a flowchart for explaining the flow of control to each unit;

FIG. 3A is a flowchart showing the flow of mail processing in FIG. 1;

FIG. 3B is a flowchart continued from FIG. 3A;

FIG. 4 is a perspective view showing the arrangement of an orientation-adjusting portion;

FIG. 5 is a perspective view showing the arrangement of a height-sizing portion and its processing method;

FIG. 6 is a side view as viewed from the direction of arrow X in FIG. 5;

FIG. 7 is a perspective view showing the structure of a facing unit;

FIG. 8 is a sectional view showing the mechanism of a sorting portion;

FIG. 9 is a top view showing the mechanism of a raising portion;

FIG. 10 is a side view as viewed from the direction of arrow X in FIG. 9;

FIG. 11 is a sectional view showing the mechanism of a merging portion;

FIG. 12 is a perspective view showing the structure of a branching unit;

FIG. 13 is a perspective view showing the arrangement of upstream processes in an apparatus with the capability of thickness sizing;

FIG. 14 is a flowchart showing the flow of mail processing in the apparatus with the capability of thickness sizing;

FIG. 15 is a perspective view showing the structure of an apparatus without any culling unit;

FIG. 16 is a flowchart showing the flow of mail processing in the apparatus without any culling unit;

FIG. 17 is a perspective view showing the structure of an apparatus without any automated feeding unit;

FIG. 18 is a flowchart showing the flow of mail processing in the apparatus without any automated-feeding unit;

FIG. 19 is a perspective view showing the structure of an apparatus with dual stacking units; and

FIG. 20 is a flowchart showing the flow of mail processing in the apparatus with dual stacking units.

### DETAILED DESCRIPTION OF THE PREFERRED EMBODIMENTS

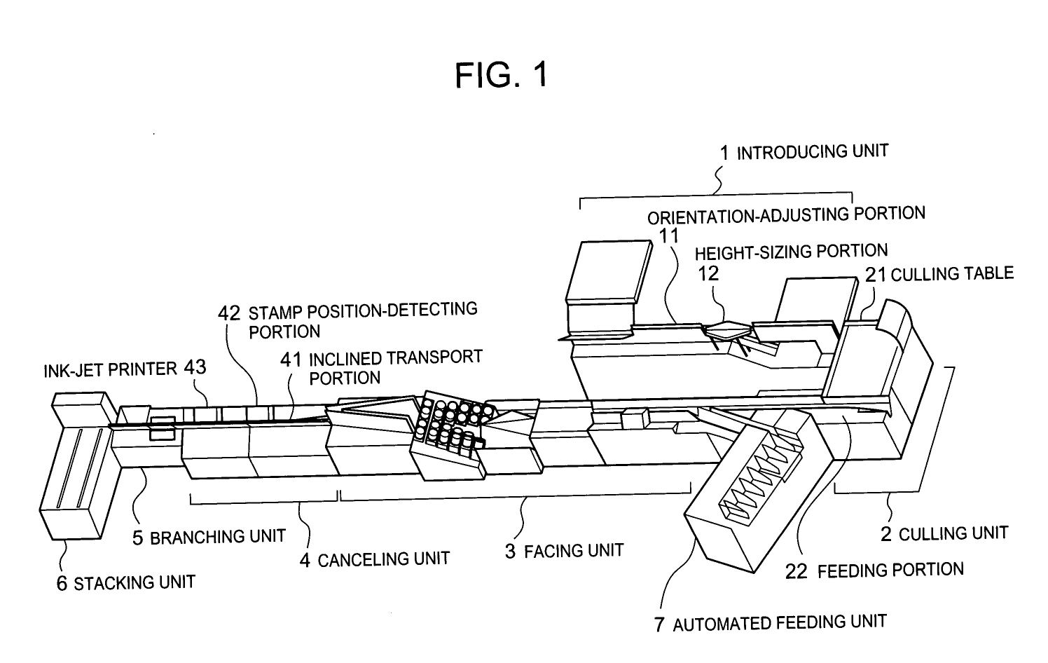

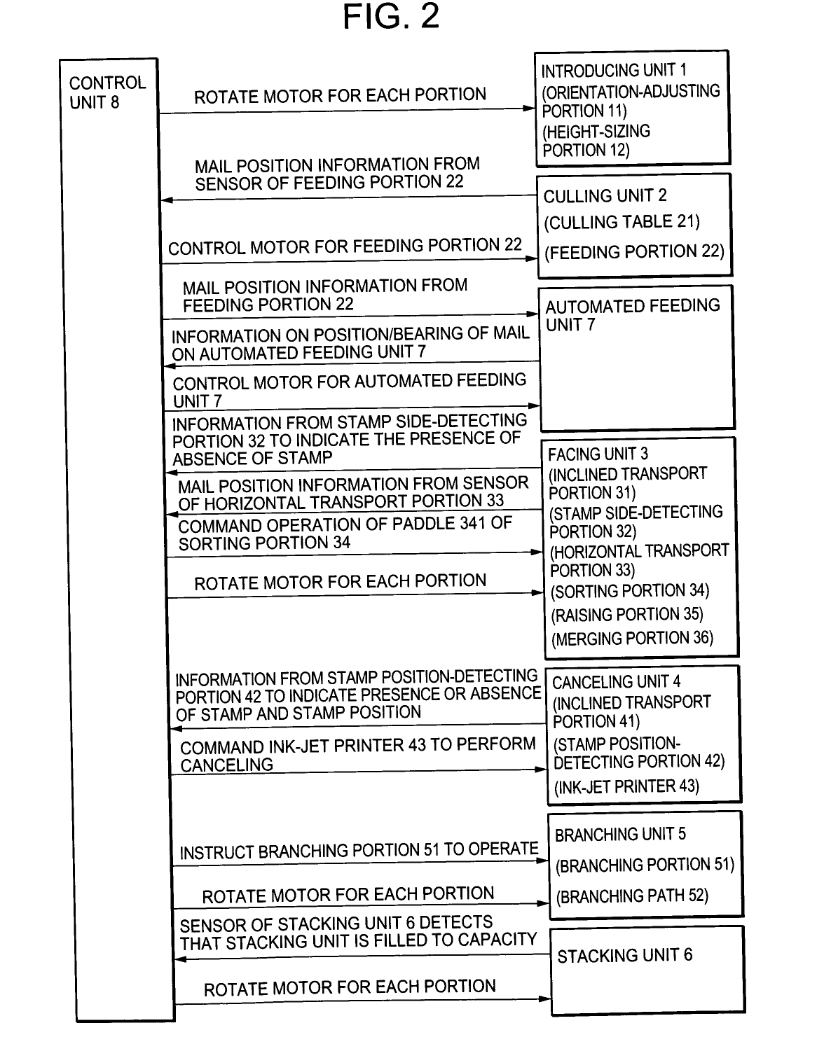

FIG. 1 is a perspective view showing the structure of an embodiment according to the present invention. FIG. 2 is a flowchart for explaining the flow of control to each unit shown in FIG. 1.

Referring to FIG. 1, a mail processing apparatus of the present invention includes an introducing unit 1 for introducing postal items to the apparatus, and a culling unit 2 for culling the postal items to be processed. The mail processing apparatus also includes a facing unit 3 for aligning the orientation of the postal items, and a canceling unit 4 for canceling the stamps on the postal items with a postmark. The mail processing apparatus further includes a branching unit 5, a stacking unit 6, an automated feeding unit 7 for feeding the postal items culled beforehand, and a control unit (not shown) for controlling each of these units. The control unit, for example, may be a personal computer for controlling the flow of mail remotely from the outside of the mail processing apparatus, or may be incorporated in the mail processing apparatus.

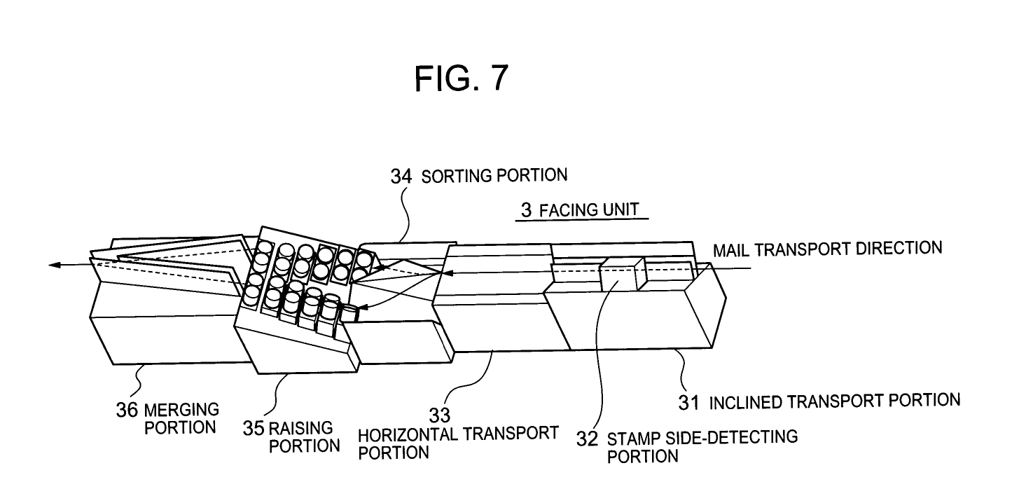

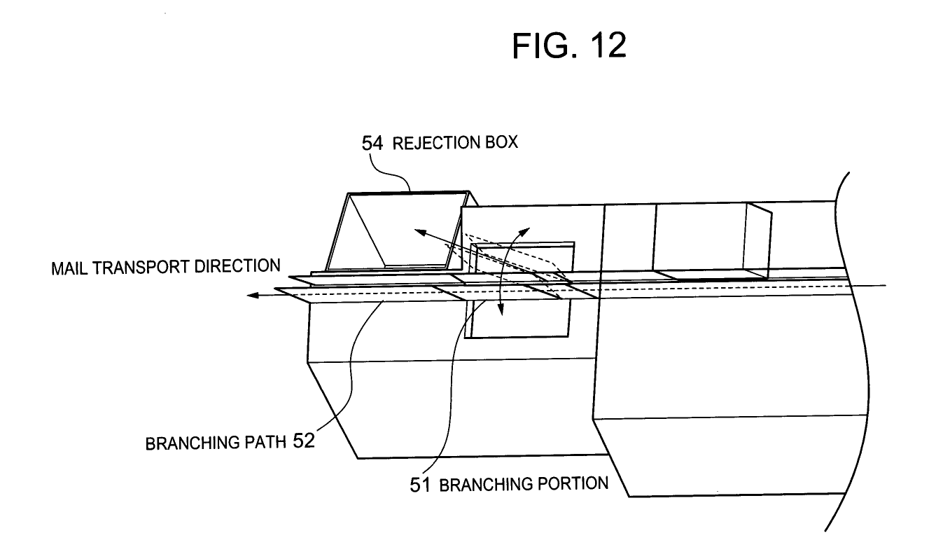

The introducing unit 1 has an orientation-adjusting portion 11 and a height-sizing portion 12. The culling unit 2 has a culling table 21 and feeding portion 22. The facing unit 3 has, as shown in FIG. 7, an inclined transport portion 31, a stamp side-detecting portion 32, a horizontal transport portion 33, a sorting portion 34, a raising portion 35, and a merging portion 36. The canceling unit 4 has an inclined transport portion 41, a stamp position-detecting portion 42, and an ink-jet printer 43. The branching unit 5 has, as shown in FIG. 12, a branching portion 51, a branching path 52, and a rejection box 54.

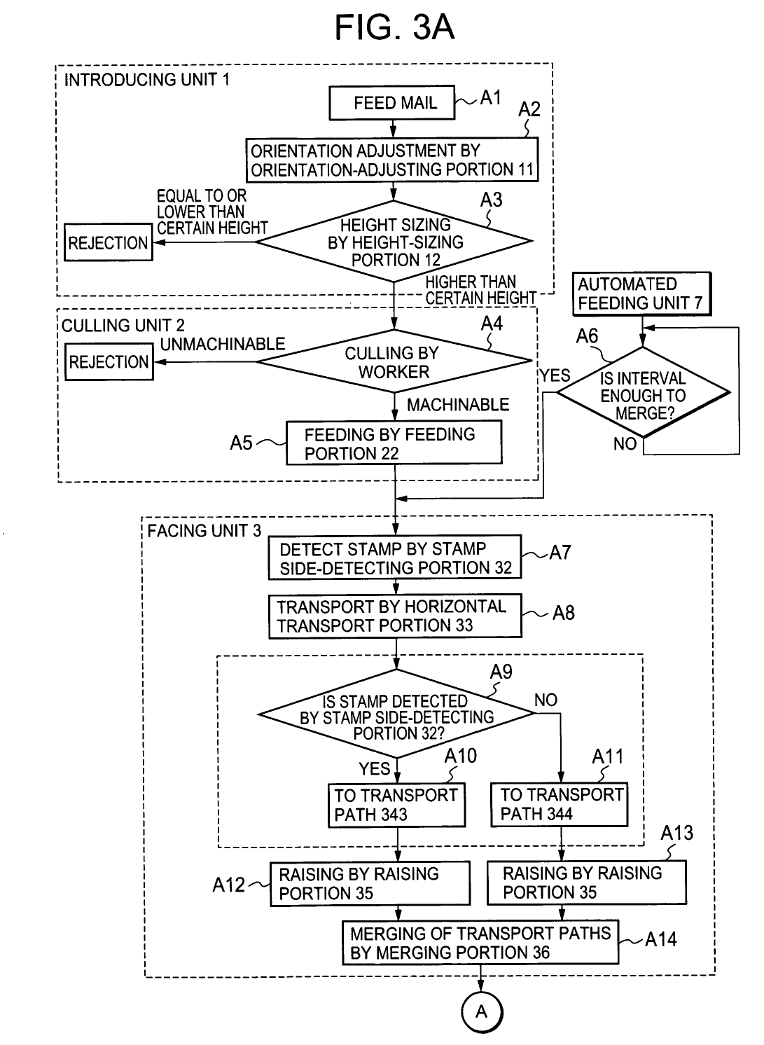

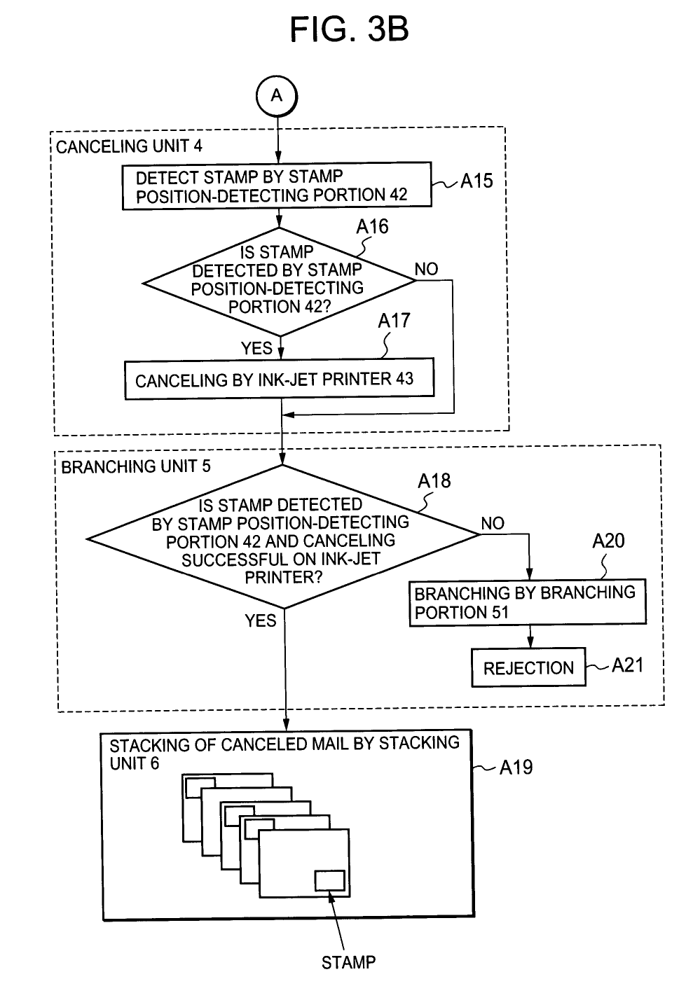

FIG. 3A is a flowchart showing the flow of mail processing in FIG. 1. FIG. 3B is a flowchart continued from FIG. 3A. Referring to FIGS. 1, 2, 3A, and 3B, an outline of the operation will be described.

The introducing unit 1 adjusts the orientation of postal items to landscape, and then picks up, as non-standard-sized mail, postal items that exceed a predetermined height (steps A1 to A3). At the culling unit 2, a worker(s) culls mechanically-processable postal items (steps A4 and A5). The facing unit 3 determines the stamp sides of the postal items and aligns them so that the stamp sides face the same direction (steps A7 to A14). The canceling unit 4 detects the position of the stamps on the postal items and cancels the stamps with a postmark (steps A15 to A17). The branching unit 5 divides the postal items into two transport destinations for cancelled mail and uncanceled mail (steps A18 to A21). The stacking unit 6 stacks the cancelled postal items (step A19).

The following describes the operation in detail.

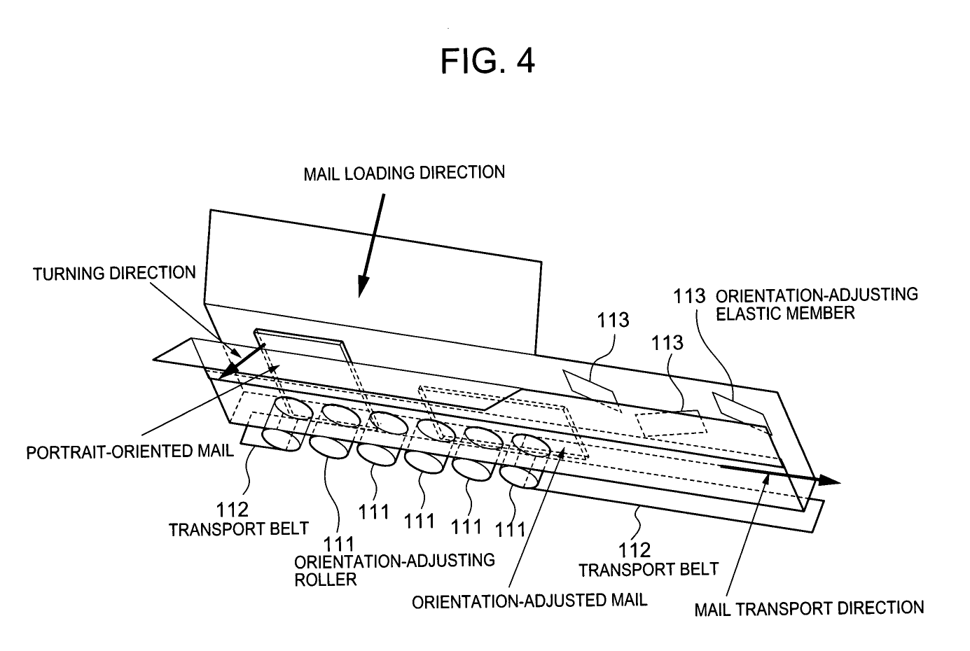

First of all, the postal items are fed from the introducing unit 1 (step A1). The postal items are fed to the introducing unit 1 in such a condition that standard-sized mail and non-standard-sized mail are mixed, and processed by the orientation-adjusting portion 11 (the arrangement of which is shown in FIG. 4). The orientation-adjusting portion 11 includes orientation-adjusting rollers 111, a transport belt 112, orientation-adjusting elastic members 113, and a motor (not shown) for driving the transport belt.

Each of the postal items is transported by the transport belt 112 to the orientation-adjusting rollers 111. Portrait-oriented items on the orientation-adjusting rollers 111, if any, are diverted from their portrait orientation by the rotation of the orientation-adjusting rollers 111 as shown in FIG. 4 so that the direction of their length coincides with the transport direction. Any postal item the orientation of which was not adjusted in the above manner by the rotation of the orientation-adjusting rollers 111 comes into contact with the orientation-adjusting elastic members 113 and its orientation is adjusted to the right direction. The postal item the orientation of which was thus diverted and adjusted is fed to the height-sizing portion 12.

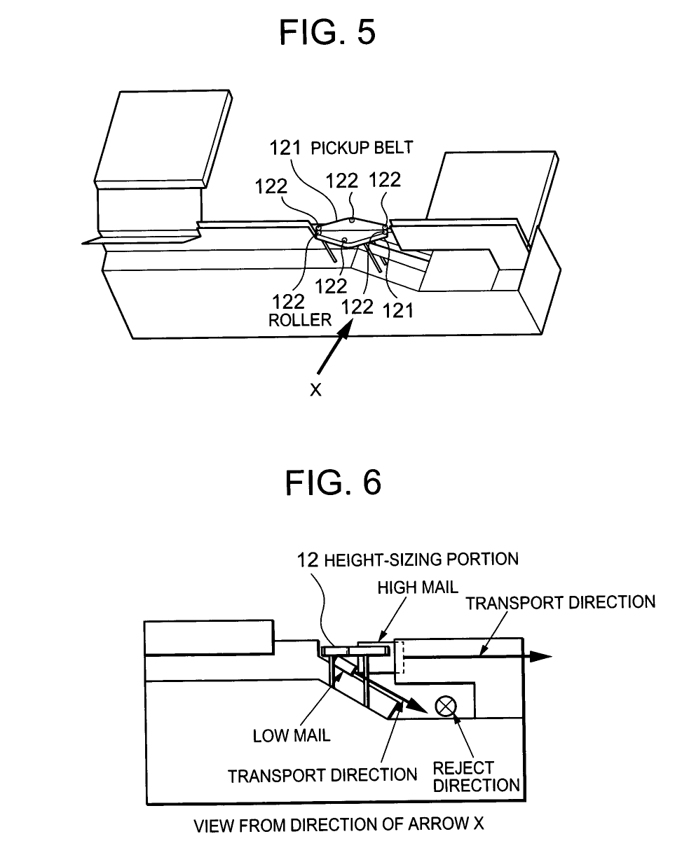

FIG. 5 is a perspective view showing the arrangement of the height-sizing portion 12 and its processing method. FIG. 6 is a side view as viewed from the direction of arrow X in FIG. 5. Referring to FIGS. 5 and 6, the height-sizing portion 12 has a pickup belt 121, rollers 122 for driving the pickup belt, and a motor (not shown) for driving the rollers 122. The pickup belt 121 and the rollers 122 of the height-sizing portion 12 are placed in a predetermined height. The height of non-standard-sized mail is higher than the predetermined height, so that the non-standard-sized mail is transported by the pickup belt 121 in the horizontal direction and fed to the culling unit 2 (step A3).

On the other hand, any other items equal to or lower in height than the predetermined height are not picked up by the pickup belt 121, and they are passed through under the pickup belt 121 toward the downstream, and removed from the apparatus as not being processed by the mail processing apparatus. The culling unit 2 has the culling table 21 and the feeding portion 22. The postal items fed from the height-sizing portion 12 are culled by worker's hand on the culling table 21 (step A4).

The worker(s) culls out mechanically-unprocessable items, for example, items requiring careful handling and items damaged or torn for some reason. Then the worker(s) supplies only the mechanically-processable items to the feeding portion 22 so that the postal items supplied are fed to the facing unit 3 one by one without fail (step A5). On the other hand, the flow of mail includes postal items from bulk users. These postal items are preclassified by the bulk users into fixed kinds of mail.

Since such postal items do not need to be culled at the introducing unit 1 and the culling unit 2, it is more efficient to automatically feed them from the automated feeding unit 7 to the facing unit 3. In this embodiment, the feeding portion 22 and the automated feeding unit 7 can be used concurrently. In the event of concurrent use, the control unit 8 controls them so that postal items are fed from the automated feeding unit 7 when a sufficient transport interval between postal items from the feeding portion 22 is available (step A6).

FIG. 7 is a perspective view showing the structure of the facing unit 3. Referring to FIG. 7, the facing unit 3 has the stamp side-detecting portion 32 on the inclined transport portion 31 to detect the presence or absence of stamps on the postal items from one side of the transport path (step A7). If no stamps are detected, it is considered that the stamps are on the other side. The postal items are then transported from the inclined transport portion 31 to the horizontal transport portion 33, and fed from the horizontal transport portion 33 to the sorting portion 34 (step A8).

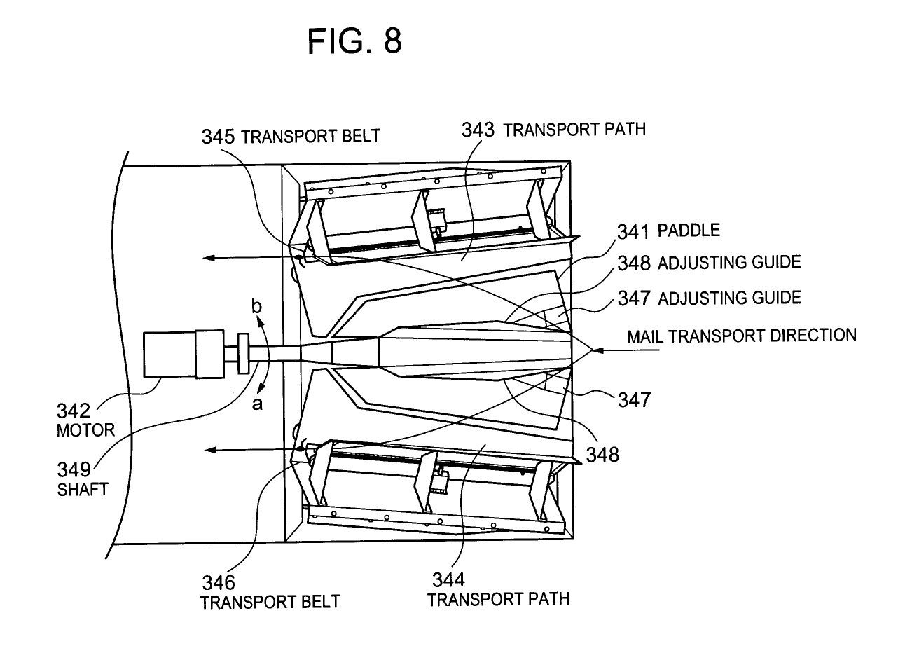

FIG. 8 is a sectional view showing the mechanism of the sorting portion 34. Referring to FIG. 8, the sorting portion 34 has a paddle 341, adjusting guides 347 and 348 provided-on the paddle 341, a shaft 349 to which the paddle is attached, and a motor 342 for driving the paddle 341 through the shaft 349. The sorting portion 34 also has transport paths 343 and 344 on both sides of the paddle 341. In the transport paths, transport belts 345 and 346, and motors (not shown) for driving the transport belts 345 and 346 are provided respectively.

When the front edge of a postal item is transported to the most downstream of the horizontal transport portion 33, that is, to the entrance of the sorting portion 34, the motor 342 drives the paddle 341 based on information from the stamp side-detecting portion 32 (step A9). If the stamp side-detecting portion 32 detects the presence of a stamp, the paddle 341 is moved in the direction of arrow a in FIG. 8 so that the item drops along the paddle 341 toward the transport path 343 (step A10).

In this operation, since the position and range of movement in which mail drops along the paddle 341 toward the transport path vary in size and weight of mail, the paddle 341 has the adjusting guides 347 and 348 to adjust the range of mail so that any kind of mail has an almost equal range to drop just before the entrance of the raising portion 35.

The adjusting guide 347 is placed in a position where it will come into contact with relatively small and light-weight mail. Such mail that tends to increase its range is adjusted by the adjusting guide 347 to reduce its range so that the mail will drop just before the entrance of the raising portion 35. The adjusting guide 348 is placed in a position where it will come into contact with relatively large, heavy-weight mail. Such mail is adjusted by the adjusting guide 348 to turn back its dropping direction so that the mail will drop just before the entrance of the raising portion 35.

On the other hand, if the stamp side-detecting portion 32 detects the absence of a stamp, the paddle 341 is moved in the direction of arrow b in FIG. 8 so that the postal item drops along the paddle 341 toward the transport path 344. In this case, the dropping position and range of the postal item are also adjusted by the adjusting guides 347 and 348. The above-mentioned operation of the paddle 341 results in the supply of a postal item to the transport path 343 or 344 in which the item is fed by the transport belt 345 or 346 to the raising portion 35.

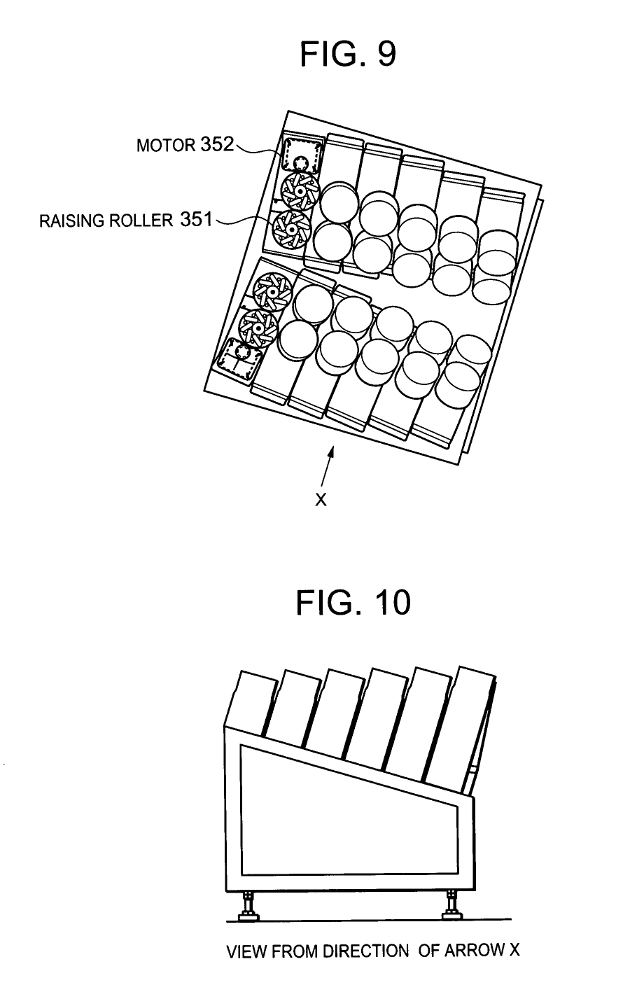

FIG. 9 is a top view showing the mechanism of the raising portion 35. FIG. 10 is a side view as viewed from the direction of arrow X in FIG. 9. Referring to FIGS. 9 and 10, the raising portion 35 has raising rollers 351 and motors 352 for driving the raising rollers. The raising rollers 351, which transport a postal item while holding it therebetween, are made of an elastic material so that they can hold therebetween items of any thickness. The raising rollers 351 in each transport path are mounted in column of twos at different mounting angles varying from tilted to erect along the transport direction so that the transported item will change its bearing from tilted to erect. Such a mechanism allows the transported item to change from a tilted state to an erect state before being fed to the merging portion 36.

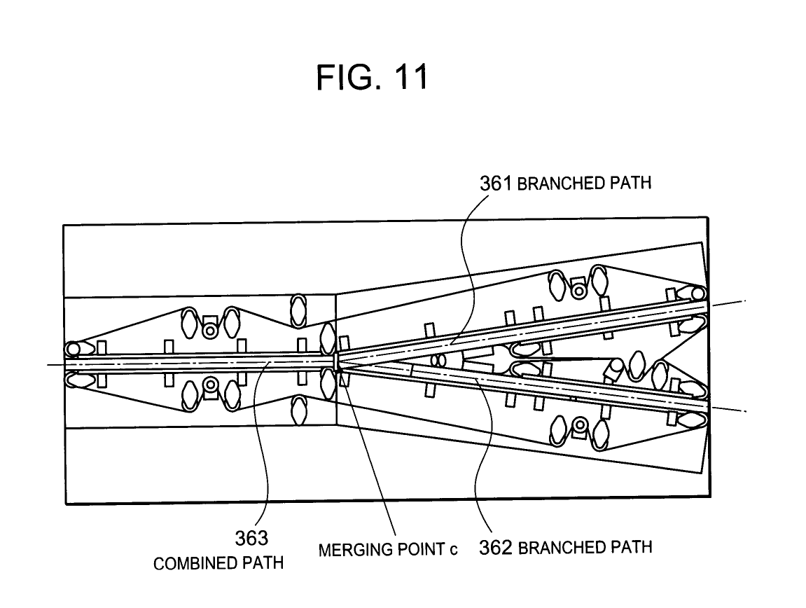

FIG. 11 is a sectional view showing the mechanism of the merging portion 36. Referring to FIG. 11, the merging portion 36 has branched paths 361 and 362, and a combined path 363. The two transport paths (branched paths 361 and 362) merge into one transport path (combined path 363) at point c (merging point) in FIG. 11. The transport paths (the branched paths 361 and 362, and the combined path 363) are in the erect state, and transport belts with motors (not shown) provided for driving the transport belts are placed on both sides and bottom of each transport path.

In this arrangement, postal items are transported in the erect state, and the postal items respectively fed from the branched paths 361 and 362 are merged at point c (merging point) in FIG. 11 (step A13). The sequence of operations of the above-described portions in the facing unit 3, namely the inclined transport portion 31, the stamp side-detecting portion 32, the horizontal transport portion 33, the sorting portion 34, the raising portion 35, and the merging portion 36, are performed to complete the process of aligning the postal items so that the stamp sides face the same direction. Use of a mechanism and method like the facing unit 3 and its facing method allows the alignment of all kinds of postal items so that the stamp sides face the same direction without fail. Therefore, the conventional problems are solved in such a manner as to make it possible to align non-standard-sized mail that varies in size, thickness, weight, etc, compared to standard-sized mail.

All the postal items aligned in the facing unit 3 re fed to the inclined transport portion 41 of the canceling unit 4. The canceling unit 4 has the inclined transport portion 41, the stamp position-detecting portion 42, and the ink-jet printer 43. The stamp position-detecting portion 42 detects the presence or absence of a stamp on each of the postal items fed to the inclined transport portion 41, and if the presence of a stamp is detected, it then detects the position of the stamp (step A15) and feeds the same to the ink-jet printer 43. The ink-jet printer 43 prints a postmark in the position of the stamp on the postal item based on information detected by the stamp position-detecting portion 42 (steps A16 and A17). If the stamp position-detecting portion 42 detects the absence of a stamp, the ink-jet printer 43 does not print the postmark.

The postal items passed through the canceling unit 4 are fed to the branching unit 5. FIG. 12 is a perspective view showing the structure of the branching unit 5. The branching unit 5 has the branching portion 51, the branching path 52, a motor (not shown) for actuating the branching portion 51, and the rejection box 54. The branching portion 51 operates in both directions indicated by arrow in FIG. 12 to divide the transport path of postal items into two branches. In other words, postal items processed in the canceling unit 4 are fed by the branching portion 51 to the branching path 52, and then to the stacking unit 6 (steps A18 and A19).

On the other hand, uncanceled postal items, that is, items with no stamp detected by the stamp position-detecting portion 42 or items with stamps on which the ink-jet printer 43 has failed to print the postmark, are diverted from the transport path into the rejection box 54. The stacking unit 6 stacks the canceled postal items fed from the branching unit 5. The mechanism of the stacking unit 6 can be realized using, for example, the mechanism described in Japanese Patent Laid-Open No. 2003-137469.

The use of the above-described mechanism and method allows the automation of the sequence of culling, facing, and canceling operations of non-standard-sized mail.

The following describes other specific examples of the present invention. Although the above described the structure of an apparatus for culling, facing, and canceling non-standard-sized mail, the following structures can be considered according to various circumstances, such as the quantities, kinds of processed mail, and the installation locations.

### (1) With a Thickness-Sizing Portion

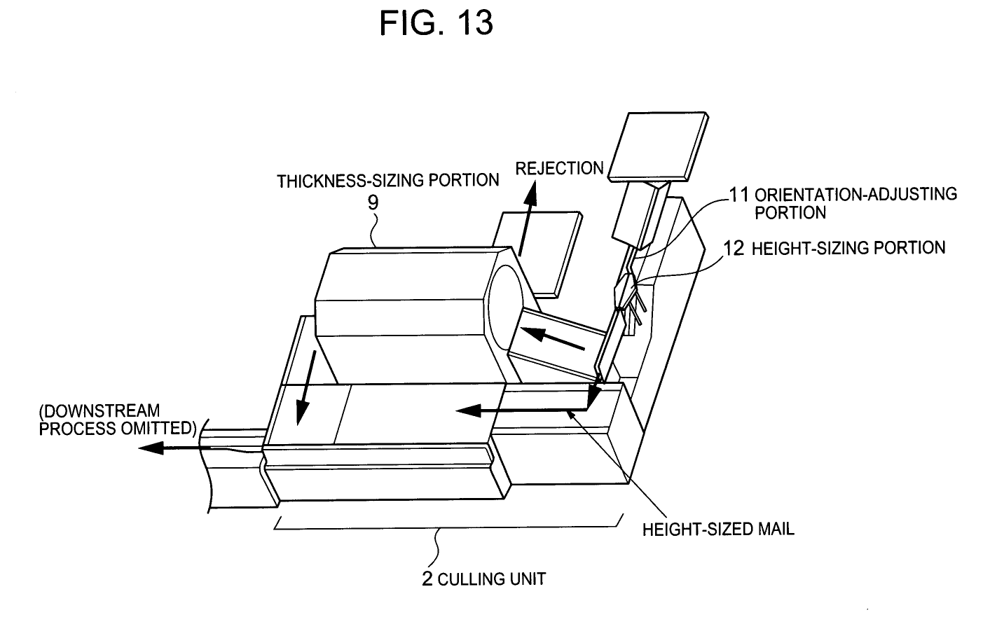

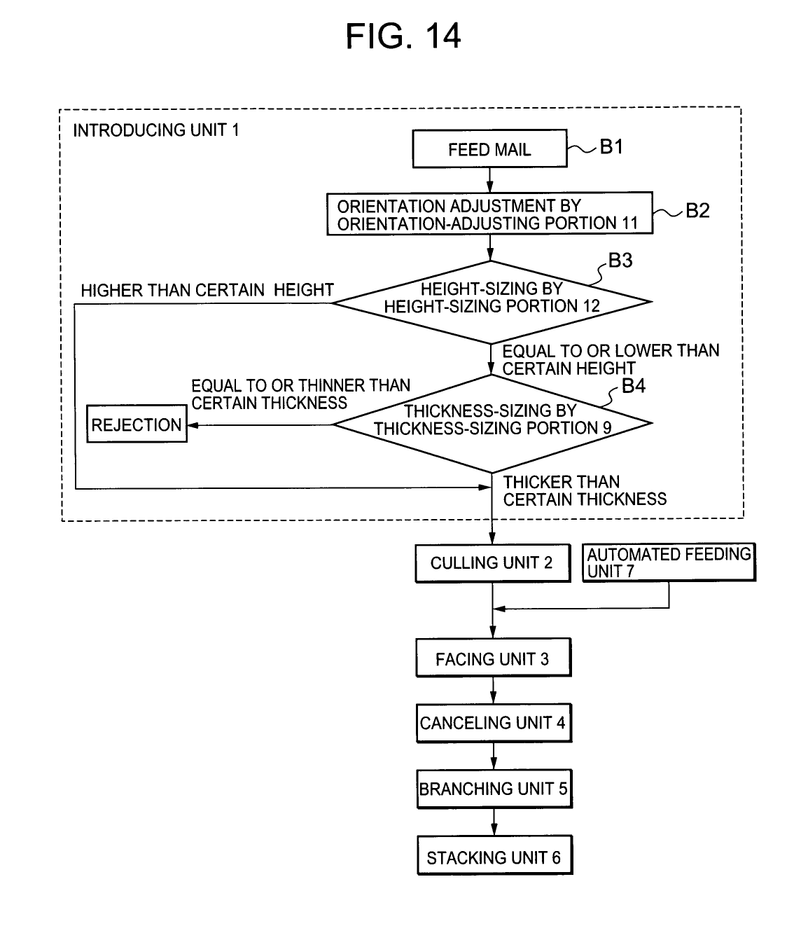

Any postal item thicker than a predetermined thickness is also handled as non-standard-sized mail, so that an apparatus with the capability of culling postal items by thickness can be considered. FIG. 13 is a perspective view showing the arrangement of upstream processes in an apparatus with the capability of culling postal items by thickness. FIG. 14 is a flowchart showing the flow of mail processing in this apparatus.

Referring to FIGS. 13 and 14, the orientation-adjusting portion 11 first adjusts the orientation of postal items (steps B1 and B2), and then the height-sizing portion 12 picks up qualified-height postal items and feeds them to the culling unit 2 as non-standard-sized mail (step B3). On the other hand, postal items that were not picked up by the height-sizing portion 12 are passed through under the height-sizing portion 12 toward the downstream, and fed to a thickness-sizing portion 9. Any postal item the thickness of which is determined by the thickness-sizing portion 9 to exceed a certain fixed value is regarded as non-standard-sized mail, and fed to the culling unit 2 (step B4). On the other hand, any postal item the thickness of which is determined to be equal or less than the certain value is removed from the apparatus as being unprocessable by the apparatus.

### (2) Without any Culling Unit

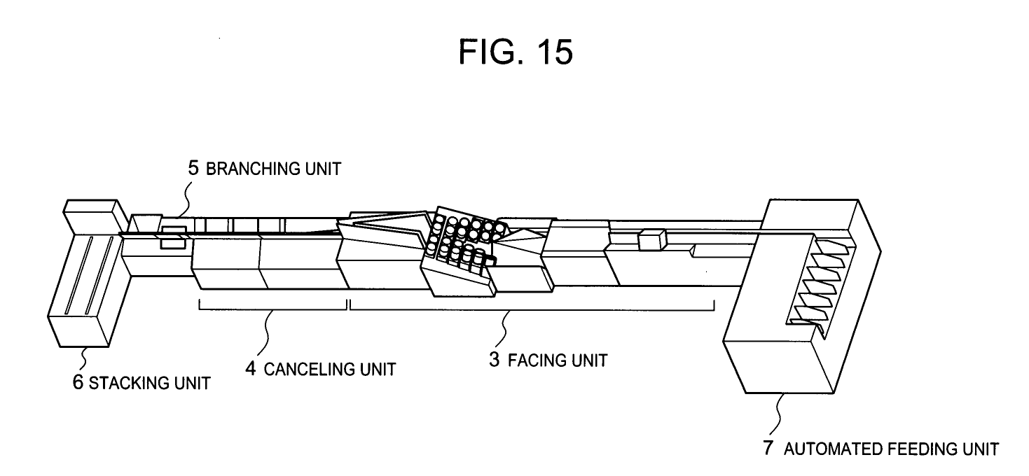

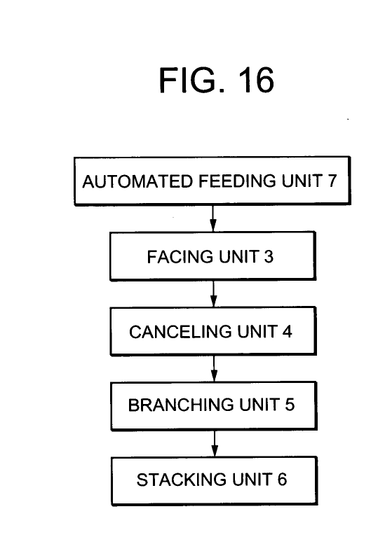

When the apparatus is designed to process only postal items that have been culled in some way from all the postal items loaded, the introducing unit (1 in FIG. 1) and the culling unit (2 in FIG. 2) do not need providing. FIG. 15 is a perspective view showing the structure of an apparatus in this case. FIG. 16 shows the flow of mail processing in this apparatus.

### (3) Without any Automated Feeding Unit

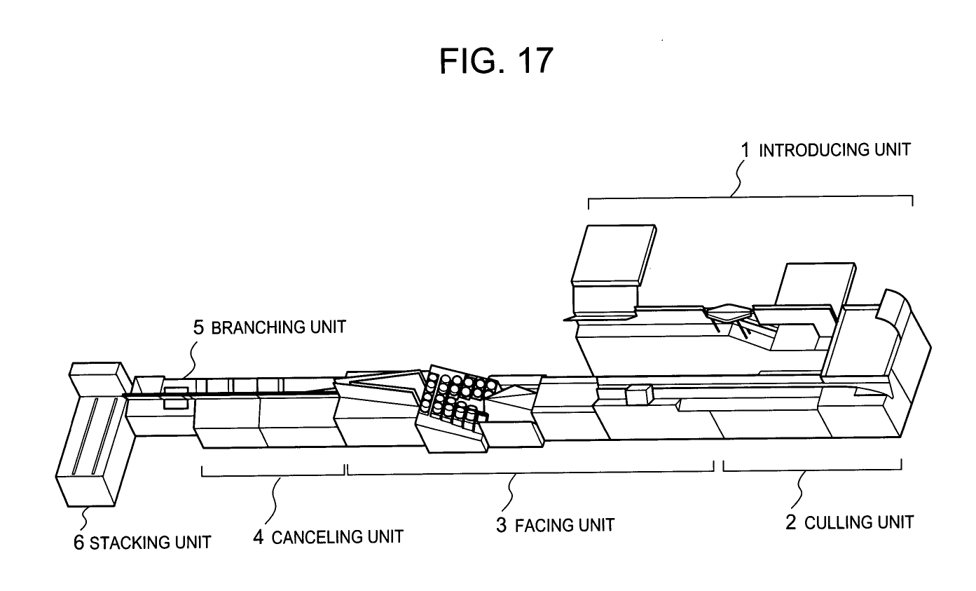

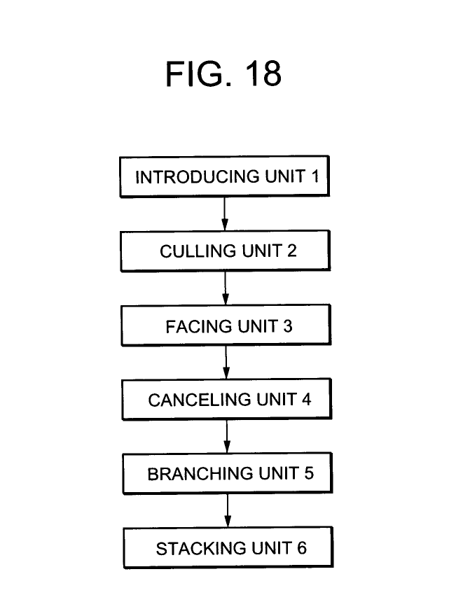

When few postal items have been culled beforehand in some way, if only the introducing unit 1 and the culling unit 2 are enough to process such postal items, the automated feeding unit (7 in FIG. 1) does not need providing. FIG. 17 is a perspective view showing the structure of an apparatus in this case. FIG. 18 shows the flow of mail processing in this apparatus.

### (4) Arrangement of Dual Stacking Units

In the arrangement of a single stacking unit, postal items with the stamps in the front end and postal items with the stamps in the rear end are mixed and stacked. In aligning the orientation of these mixed postal items to face the same direction, two stacking units 6 can be provided for separate stacking of the postal items, depending on whether the stamps are in the front end or rear end. This arrangement makes it easy for the worker(s) to align the postal items when taking them out of both the stacking units 6.

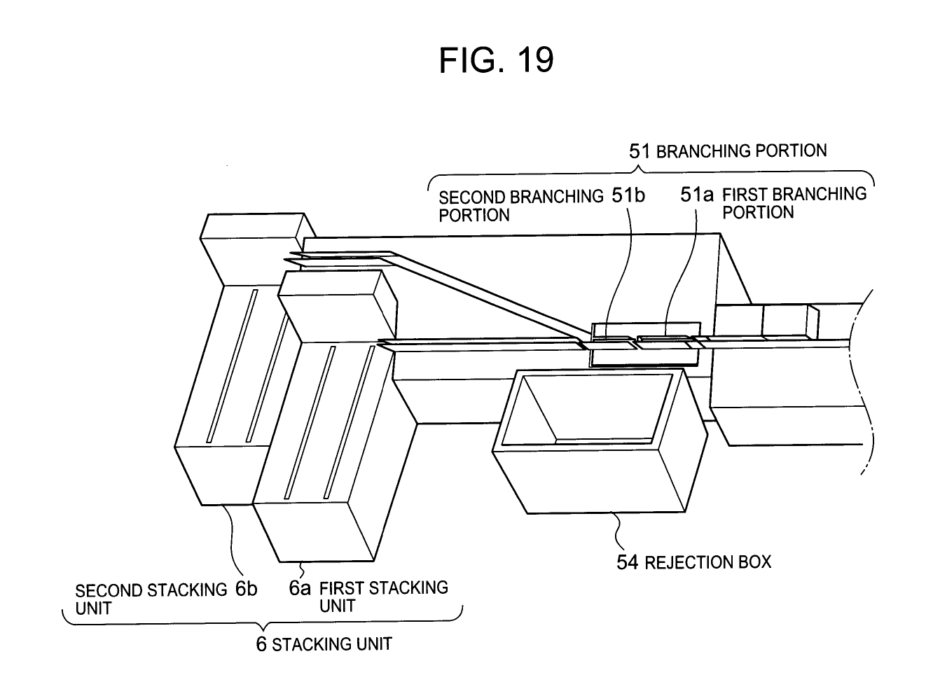

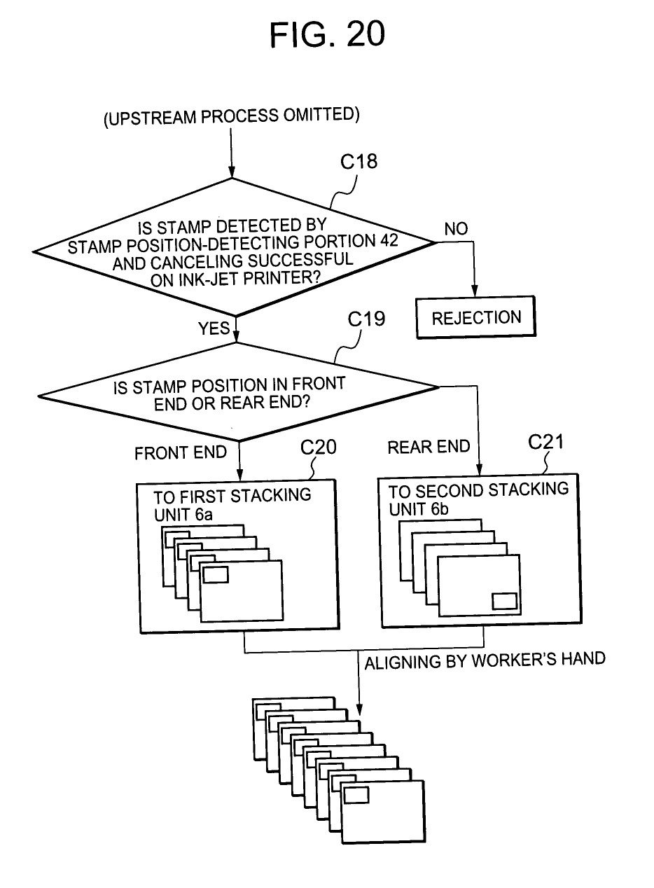

FIG. 19 is a perspective view showing the structure of an apparatus provided with dual stacking units 6. FIG. 20 is a flowchart showing the flow of mail processing (downstream processes from the branching unit) in this apparatus. In this case, the arrangement is provided with dual branching portions 51 and dual stacking units 6. In operation, postal items canceled in the canceling unit (4 in FIG. 1) are fed by a first branching portion 51a to a second branching portion 51b (step C18). On the other hand, uncanceled postal items, that is, items with no stamps detected by the stamp-detecting portion 42 and items with stamps on which the ink-jet printer 43 has failed to print the postmark, are diverted by the branching portion 51 from the transport path into the rejection box 54.

The postal items fed to the second branching portion 51b are separated based on the information on their stamp positions detected by the stamp position-detecting portion 42. In this case, the postal items with the stamps affixed in the front end are stacked in a first stacking unit 6a and the postal items with the stamps affixed in the rear end are stacked in a second stacking unit 6b (steps C19, C20, and C21). After completion of this processing, the worker(s) can easily align the orientation of the postal items stacked in the respective stacking units.

### (5) Sealing Hub

Instead of the ink-jet printer 43, a sealing hub for mechanical sealing of a postmark may be used as canceling means.

As described above, according to the present invention, a sequence of operations for culling, facing, and canceling non-standard-sized mail is significantly automated, thereby processing large amounts of mail securely in a shorter amount of time. Further, the sequence of operations for culling, facing, and canceling non-standard-sized mail that has required a great many manual workers in the conventional system can be performed by a single machine operator. These two effects also make them possible to eliminate human error and cut down on the cost of mail processing.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. A mail processing apparatus comprising:
a stamp side-detecting portion for determining on which side of each of postal items a stamp is affixed;
a sorting portion for sorting the postal items based on information determined by said stamp side-detecting portion; and
a facing portion for aligning the postal items so that their stamp sides face the same direction.

2. A mail processing apparatus comprising:
a stamp side-detecting portion for determining on which side of each of postal items a stamp is affixed;
a sorting portion for sorting the postal items based on information determined by said stamp side-detecting portion; and
a facing portion for aligning the postal items so that their stamp sides face the same direction, wherein
said facing portion has multiple rollers with different mounting angles varying from tilted to erect, and a raising portion for raising the postal items sorted by said sorting portion so that the bearings of the postal items are changed from tilted to erect.

3. The apparatus according to claim 1, further comprising:
an orientation-adjusting portion for adjusting the orientation of the postal items so that the direction of their length coincides with the transport direction; and
a feeding portion for feeding the orientation-adjusted postal items to said stamp side-detecting portion.

4. The apparatus according to claim 1 further comprising a height-sizing portion for picking up postal items higher than a predetermined height so that the picked up postal items are fed to said stamp side-detecting portion.

5. The apparatus according to claim 1 further comprising a thickness-sizing portion for picking up postal items thicker than a predetermined thickness so that the picked up postal items are fed to said stamp side-detecting portion.

6. The apparatus according to claim 1 further comprising:
a height-sizing portion for picking up postal items higher than a predetermined height while passing the other postal items equal to or lower than the predetermined height through under said height-sizing portion toward the downstream; and
a thickness-sizing portion for picking up postal items thicker than a predetermined thickness from among the postal items passed through by said height-sizing portion, wherein
the picked up postal items are fed to said stamp side-detecting portion.

7. The apparatus according to claim 1, further comprising:
a stamp position-detecting portion for detecting the position of a stamp on each of the postal items aligned by said facing portion; and
canceling means for canceling the postal items based on information from said stamp position-detecting portion.

8. The apparatus according to claim 7, wherein said canceling means seals a postmark on the stamps.

9. The apparatus according to claim 7, further comprising a branching unit for dividing the transport destination into a branch for canceled postal items and a branch for uncanceled postal items.

10. The apparatus according to claim 7, further comprising a stacking unit for stacking the canceled postal items.

11. The apparatus according to claim 7, further comprising means for dividing the destination of the postal items into branches according to the stamp positions based on information from said stamp position-detecting portion.

12. The apparatus according to claim 7, further comprising means for dividing the destination of the postal items into two branches, one for postal items with the canceled stamps in the front end and the other for postal items with the canceled stamps in the rear end, based on information from said stamp position-detecting portion.

13. The apparatus according to claim 12, further comprising:
a first stacking unit for stacking the postal items with the canceled stamps in the front end; and
a second stacking unit for stacking the postal items with the canceled stamps in the rear end.

14. The apparatus according to claim 4, further comprising a culling unit where a worker(s) culls the postal items picked up by said height-sizing portion and feeds the culled postal items to said feeding portion.

15. The apparatus according to claim 1, further comprising an automated feeding unit for automatically feeding the postal items culled beforehand to the stamp side-detecting portion.

16. The apparatus according to claim 3, wherein said orientation-adjusting portion uses rollers and belts to change the bearings of the postal items from a tilted state to an erect state.

17. The apparatus according to claim 1, wherein said sorting portion has a paddle driven based on the information detected by said stamp side-detecting portion.

18. The apparatus according to claim 1, wherein said sorting portion has guide members for adjusting the ranges of the postal items when sorted.

19. The apparatus according to claim 1, wherein said facing portion has a raising portion for raising the postal items sorted by said sorting portion so that the postal items are transported in an erect state.

20. The apparatus according to claim 19, wherein said raising portion has multiple rollers with different mounting angles varying from tilted to erect.

21. The apparatus according to claim 20, wherein said rollers are made of an elastic material.
